(19) United States
(12) Patent Application Publication
(10) Pub. No.: US 2008/0035023 A1
(43) Pub. Date: Feb. 14, 2008

(54) Construction Materials Containing Polyester Fibers

(76) Inventors: Michael Wessling, Kandern (DE); Alexander Lerch, Gelnhausen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/630,423

(22) PCT Filed: Jun. 21, 2005
(86) PCT No.: PCT/EP05/06664

§ 371 Date: Dec. 22, 2006

(30) Foreign Application Priority Data
Jun. 30, 2004 (DE) 10 2004 031 629.5

(51) Int. Cl. C04B 16/06; C08K 5/05; C08K 5/13; C08K 5/42; C08L 67/03

(52) U.S. Cl. 106/287.24; 524/157; 524/251; 524/289; 524/323; 524/394; 525/444

(57) ABSTRACT

The invention relates to construction materials, in particular concrete, which contain polyester fibers. The polyester fibers are treated with an oligoester to improve their incorporation into the construction materials.

The invention relates to construction materials, in particular concrete, which comprise polyester fibers and additionally an oligoester.

The properties of concrete such as compressive strength, tensile strength, flexural strength, elasticity, hardness etc. can be modified by the mixing ratio, by the choice of the starting substances, and by additives. To increase the strength, rod-like composite materials made from very fine glass fibers or synthetic fibers, for example fibers made from poly-propylene, polyethylene, polyoxymethylene, poly(ethylene terephthalate), poly(butylene terephthalate), polyamides, rayon etc. are added. Adhesives, composite materials, rubber, rubber products, plastic materials, synthetic resins etc. can be admixed for modification of the properties of the fibers. The integration of the fibrous additives into the construction materials, in particular into concrete, can be carried out by different methods. Thus the fibrous material can be packaged in water-soluble materials and the packages can be added to the concrete during the mixing process. The packaging material dissolves and the fibrous material is dispersed in the cement/water/additive mixture. By addition of dispersants, for example condensation products of naphthalenesulfonate and formaldehyde or melaminesulfonate and formaldehyde, to the concrete mixture, the fluidity is improved and the homogeneous dispersion of the fibers in the material is favored. A disadvantage is a high “slump loss”, that is a loss of viscosity and, resulting thereby, more rapid sedimentation, and a longer hardening time of the concrete.

According to U.S. Pat. No. 5,753,368, the integration of fibers into concrete can be improved if the fibers are treated with a glycol ether or glycerol ether. It is known from IP 07-300773 to incorporate aramid fibers in cement, the aramid fibers being coated with a mixture of an anionically modified oligoester, a wax and a polysiloxane.

The methods of the prior art for the incorporation of fibrous material into concrete do not solve the problems such as sedimentation, unfavorable intrinsic viscosity, caking of the fibrous material and inadequate dispersion of the fibers in the required amounts in the concrete mixture in a completely satisfactory manner.

It has been found that the addition of oligoesters to the liquid concrete mixture, consisting essentially of cement, additives (e.g. shingle, gravel, chippings, sand), fibrous material and optionally concrete additives, significantly favors the finely divided miscibility of the hydrophobic fibers in the aqueous mixture without adversely influencing the intrinsic viscosity of the concrete mixture, the proneness to setting, the processability and setting time of the concrete. It is particularly advantageous to treat the polyester fibers with oligoesters before mixing with concrete, as a result of which the hydrophilicity of the fibers is improved and the affinity for the aqueous medium is increased.

The invention relates to construction materials, preferably concrete, comprising polyester fibers and oligoesters.

These oligoesters are obtained by polycondensation of one or more aromatic dicarboxylic acids or their esters with ethylene glycol and/or propylene glycol and or butylene glycol. If appropriate, these esters can also comprise polyethylene glycol, polypropylene glycol, sulfoisophthalic acid, hydroxyethanesulfonic acid, sulfobenzoic acid, isethionic acid, C₁-C₄-alcohols, alkoxylated C₁-C₂₄-alcohols, alkoxylated C₆-C₁₈-alkylphenols and/or alkoxylated C₈-C₂₄-alkylamines as monomers.

In particular, the use is preferred of those oligoesters which are obtained by polycondensation of
I) 10 to 50% by weight, preferably 15 to 30% by weight, of one or more dicarboxylic acids or their esters,
II) 2 to 50% by weight, preferably 5 to 45% by weight, of ethylene glycol and/or propylene glycol,
III) 3 to 80% by weight, preferably 5 to 75% by weight, of polyethylene glycol and/or methyl polyglycol,
IV) 0 to 10% by weight of a water-soluble addition product of 5 to 80 mol of an alkylene oxide to 1 mol of C₁-C₂₄-alcohols, C₆-C₁₈-alkylphenols or C₈-C₂₄-alkylamines and
V) 0 to 10% by weight of one or more polyols having 3 to 6 hydroxyl groups.

Equally preferred is the use of those oligoesters which are obtained by polycondensation of
Ia) 25 to 70% by weight, preferably 30 to 50% by weight, of one or more non sulfo group-containing dicarboxylic acids or their esters,
Ib) 5 to 20% by weight, preferably 10 to 15% by weight, of an ester of a sulfo-containing carboxylic acid, in particular dimethyl sulfo-isophthalate,
Ic) 5 to 20% by weight, preferably 10 to 15% by weight, of a sulfo-containing carboxylic acid,
II) 10 to 40% by weight, preferably 20 to 30% by weight, of ethylene glycol and/or propylene glycol.

A suitable component I) for the preparation of the copolyesters is, for example, terephthalic acid, phthalic acid, isophthalic acid and the mono- and dialkyl esters with C₁-C₆-alcohols, such as dimethyl terephthalate, diethyl terephthalate and di-n-propyl terephthalate, dimethyl terephthalate being particularly preferred. Further examples of compounds which can be employed as component I) for the preparation of the polyesters are oxalic acid, succinic acid, glutamic acid, adipic acid, fumaric acid, maleic acid, itaconic acid, and also the mono- and dialkyl esters of the carboxylic acids with C₁-C₆-alcohols, e.g. diethyl oxalate, diethyl succinate, diethyl glutarate, methyl adipate, diethyl adipate, di-n-butyl adipate, ethyl fumarate and dimethyl maleate. If the possible dicarboxylic acids can form anhydrides, the anhydrides of the carboxylic acids containing at least 2 carboxyl groups are also suitable as a compound of component a) for the preparation of the oligoesters, e.g. maleic anhydride, phthalic anhydride or succinic anhydride. Particularly preferred compounds of component I) employed are terephthalic acid, phthalic acid, isophthalic acid and their dimethyl, diethyl, dipropyl and dibutyl esters. It is, of course, possible to employ mixtures of various carboxylic acids or various esters. Equally, mixtures of carboxylic acids and esters or mixtures of carboxylic acids and anhydrides can also be used in the condensation.

As component III) polyethylene glycols having molar masses of from 500 to 5000, preferably from 1000 to 3000, are used.

As a component IV) for the preparation of the oligoesters, water-soluble addition products of 5 to 80 mol of at least one alkylene oxide to 1 mol of C₁-C₂₄-alcohols, C₆-C₁₈-alkylphenols or C₈-C₂₄-alkylamines are possible. Monomethyl ethers of polyethylene glycols are preferred. The alkylene oxides used for the preparation of the compounds of component IV) are preferably ethylene oxide and also mixtures of ethylene oxide and propylene oxide. Mixtures of ethylene oxide together with propylene oxide and/or butylene oxide, mixtures of ethylene oxide, propylene oxide and isobutylene oxide or mixtures of ethylene oxide and at least one butylene oxide are moreover suitable. These water-soluble addition products of the alkylene oxides are surfactants. If mixtures of alkylene oxides were used for their preparation, they can comprise the alkylene oxides in blocks or alternatively in a random distribution.

Suitable alcohols which are alkoxylated, are, for example, octyl alcohol, decyl alcohol, lauryl alcohol, myristyl alcohol or stearyl alcohol, but in particular methanol, and also the alcohols having 8 to 24 C atoms obtainable according to the Ziegler process or the corresponding oxo alcohols. Of the alkylphenols, in particular octylphenol, nonylphenol and dodecylphenol are of importance.

Of the possible alkylamines, in particular the C₁₂-C₁₈-monoalkylamines are used.

Suitable polyols (component V) are, for example, pentaerythritol, trimethylolethane, trimethylolpropane, 1,2,3-hexanetriol, sorbitol, mannitol and glycerol.

The following structural formulae I and II show, by way of example, the chemical structure of oligoesters: 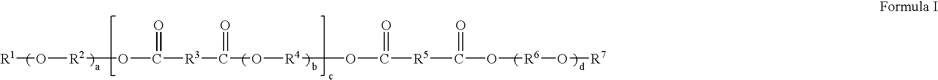
R¹ and R⁷ are linear or branched C1-C18 alkyl
R², R⁴, R⁶ are alkylene, e.g. ethylene, propylene, butylene
R³ and R⁵ are 1,4-phenylene, 1,3-phenylene
a, b, and d are a number between 1 and 200
c is a number between 1 and 20 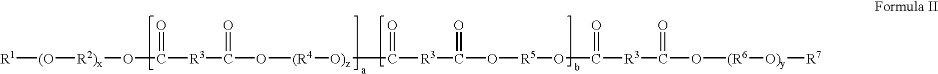
R¹ and R⁷ are linear or branched C₁-C₁₈-alkyl,
R² and R⁶ are ethylene,
R³ is 1,4-phenylene,
R⁴ is ethylene,
R⁵ is ethylene, 1,2-propylene or random mixtures of any desired composition of the two,
x and y independently of one another are a number between 1 and 500,
z is a number between 10 and 140,
a is a number between 1 and 12,
b is a number between 7 and 40,
   where a+b is at least equal to 11.

Preferably, independently of one another
R¹ and R⁷ are linear or branched C₁-C₄-alkyl,
x and y are a number between 3 and 45,
z is a number between 18 and 70,
a is a number between 2 and 5,
b is a number between 8 and 12,
a+b is a number between 12 and 18 or between 25 and 35.

The oligoesters according to the invention are synthesized by processes known per se, by first heating the components I, II and III and, if appropriate, IV and V to temperatures of 160 to about 220° C. at normal pressure with addition of a catalyst. The reaction is then continued in vacuo at temperatures of 160 to about 240° C. while distilling off excess glycols. The known transesterification and condensation catalysts of the prior art such as, for example, titanium tetraisopropoxide, dibutyltin oxide or antimony trioxide/calcium acetate are suitable for the reaction. With respect to further details for carrying out the process, reference is made to EP 442 101.

Also particularly suitable are the polyesters known from EP 241 995, which in addition to oxyethylene groups and terephthalic acid units comprise 1,2-propylene, 1,2-butylene and/or 3-methoxy-1,2-propylene groups and also glycerol units and are end group-capped with C₁-C₄-alkyl groups, the polymers described in EP 253 567 having a molar mass of 900 to 9000 g/mol formed from ethylene terephthalate and polyethylene oxide terephthalate, the polyethylene glycol units having molecular weights of 300 to 3000 g/mol and the molar ratio of ethylene terephthalate to polyethylene oxide terephthalate being 0.6 to 0.95, and the polyesters having polypropylene terephthalate and polyoxyethylene terephthalate units known from EP 272 033, which are at least proportionally end group-capped by C₁-C₄-alkyl or acyl radicals.

Oligoesters of ethylene terephthalate and polyethylene oxide terephthalate are likewise preferred in which the polyethylene glycol units have molecular weights of 750 to 5000 g/mol and the molar ratio of ethylene terephthalate to polyethylene oxide terephthalate is 50:50 to 90:10 as described in DE 28 57 292, and also oligoesters having molecular weights of 15 000 to 50 000 g/mol formed from ethylene terephthalate and polyethylene oxide terephthalate, the polyethylene glycol units having molecular weights of 1000 to 10 000 g/mol and the molar ratio of ethylene terephthalate to polyethylene oxide terephthalate being 2:1 to 6:1, as defined in DE 33 24 258.

For improving the solubility, hydrotropes, for example cumene-, toluene- or xylenesulfonate can be admixed to oligoesters in the amounts by weight of 0 to 20%, preferably 5 to 10%, based on the oligoester.

The construction materials according to the invention comprise polyester fibers, in particular polyethylene terephthalates, polypropylene terephthalates and polybutylene terephthalates, and also, if appropriate, further fibrous material, such as glass fibers, carbon fibers, nylon, metal fibers.

The fibrous material is employed in the amounts from 0.005 kg to 20 kg, preferably 0.05 kg to 10 kg, relative to 1 cubic meter of concrete.

In a preferred embodiment, the polyester fibers are treated with the above-mentioned oligoesters before adding to the concrete mixture and the hydrophilicity of the fibers is thereby improved. To this end, the fibrous material is mixed with an aqueous solution or with an aqueous dispersion of oligoester and optionally dried. The application of the oligoesters to the fibrous surface can be carried out by spraying on an aqueous solution or dispersion of the oligoesters in a spray tower.

The weight ratio of polyester fibers to oligoester, relative to 100% oligoester, is 10 000 to 0.01% by weight, preferably 5000 to 0.1% by weight, particularly preferably 1000 to 0.2% by weight.

1. A construction material comprising polyester fiber and an oligoester, prepared by polycondensation of one or more aromatic dicarboxylic acids or their esters with a glycol selected from the group consisting of ethylene glycol, propylene glycol, butylenes glycol, and mixtures thereof and optionally, with a component selected from the group consisting of a polyethylene glycol, a polypropylene glycol, sulfoisophthalic acid, hydroxyethanesulfonic acid, sulfobenzoic acid, isethionic acid, a C₁-C₄-alcohol, an alkoxylated C₈-C₂₄-alcohol, an alkoxylated C₆-C₁₈-alkylphenol, an alkoxylated C₈-C₂₄-alkylamine, and mixtures thereof.

2. (canceled)

3. A construction material comprising polyester fiber and an oligoester prepared by polycondensation of
I) 10 to 50% by weight of one or more dicarboxylic acids or their esters;
II) 2 to 50% by weight of ethylene glycol or propylene glycol or a mixture thereof,
III) 3 to 80% by weight of polyethylene glycol or methyl polyglycol or a mixture thereof,
IV) 0 to 10% by weight of a water-soluble addition product having a ratio of 5 to 80 mol of an alkylene oxide to 1 mol of a second component selected from the group consisting of a C₁-C₂₄-alcohol, a C₆-C₁₈-alkylphenol, a C₈-C₂₄-alkylamine, and mixtures thereof, and
V) 0 to 10% by weight of one or more polyols having 3 to 6 hydroxyl groups.

4. A construction material comprising polyester fiber and an oligoester prepared by polycondensation of
Ia) 25 to 70% by weight of one or more non sulfo group-containing dicarboxylic acid or ester thereof,
Ib) 5 to 20% by weight of an ester of a sulfo-containing carboxylic acid,
Ic) 5 to 20% by weight of a sulfo-containing carboxylic acid,
Id) 10 to 40% by weight of ethylene glycol or propylene glycol or a mixture thereof.

5. The construction material as claimed in claim 1, wherein the construction material further comprises concrete.

6. The construction material as claimed in claim 1, wherein a weight ratio of polyester fiber to oligoester, relative to 100% oligoester, is 10000 to 0.01% by weight.

7. The construction material as claimed in claim 1, the weight ratio of polyester fiber to oligoester, relative to 100% oligoester, being 5000 to 0.1% by weight.

8. The construction material as claimed in claim 1, the weight ratio of polyester fiber to oligoester, relative to 100% oligoester, being 1000 to 0.2% by weight.

9. The construction material of claim 4, wherein component 1a) ranges from 30 to 50% by weight.

10. The construction material of claim 4, wherein component 1b) ranges from 10-15% by weight.

11. The construction material of claim 4, wherein component 1b) is dimethyl sulfo-isophthalate.

12. The construction material of claim 4, wherein component 1c) ranges from 10-15% by weight.

13. The construction material of claim 4, wherein component 1d) ranges from 20-30% by weight.

14. The construction material of claim 4, wherein the construction material further comprises concrete.

15. The construction material of claim 3, wherein the construction material further comprises concrete.
